(19) United States
(12) Patent Application Publication
(10) Pub. No.: US 2007/0231220 A1
(43) Pub. Date: Oct. 4, 2007

(54) Method and apparatus for producing and dispensing a cleaning solution

(76) Inventors: George John Agius, Mississauga (CA); Cornelis H. Groenewegen, Middletown, OH (US); Richard L. Sampson, Fair Oaks Ranch, TX (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 11/359,841

(22) Filed: Feb. 22, 2006

Related U.S. Application Data
(60) Provisional application No. 60/654,984, filed on Feb. 22, 2005.

(51) Int. Cl. B01J 19/00; B67B 7/00; B67D 5/60

(52) U.S. Cl. 422/129

(57) ABSTRACT

A method and apparatus for producing and dispensing a cleaning solution. The cleaning solution is produced by reacting chemicals within a dispensing apparatus. In one embodiment, the dispensing apparatus has a conduit containing a catalyst or reactant. As a precursor passes through the conduit, it reacts to form a cleaning solution. The cleaning solution is then stored in a tank prior to being dispensed. In another embodiment, the dispensing apparatus has a first portion containing a precursor used to produce the cleaning solution and a second portion containing one or more reactants or a catalyst used to produce the cleaning solution. During the dispensing operation, the contents of the first portion contact the contents of the second portion, which cause a chemical reaction to produce the cleaning solution. In some embodiments, one or more portions of the dispensing apparatus are placed on a mobile platform.

### CROSS REFERENCE TO RELATED APPLICATIONS

This claims priority under 35 U.S.C. §119(e) to U.S. provisional patent application No. 60/654,984 filed on Feb. 22, 2005.

### BACKGROUND

In some cleaning applications, one or more chemicals are reacted to form a cleaning solution when needed. During such cleaning applications, the cleaning process can be delayed or prolonged according to the amount of time needed to generate the cleaning product. Furthermore, depending upon the amount of cleaning solution needed, high demands can be placed on the reaction device or devices, such as ion exchange beds or catalyst containers, to satisfy peak demands. In order to expedite the production of cleaning solution, the reaction devices can tend to be quite large to allow a large amount of reactants or intermediate cleaning products to react in a timely manner. In one particular example, some conventional clean-in-place systems use a cleaning solution that is produced via chemical reaction just prior being used. However, because a clean-in-place system can require a large quantity of cleaning solution, the cleaning process can be significantly delayed waiting for the proper amount of cleaning solution to be produced.

Chlorine dioxide (ClO₂) can be used as the cleaning solution in some applications. Chlorine dioxide is known to have bleaching, disinfecting and sterilizing properties. For example, chlorine dioxide is a powerful viricide, bactericide, protocide, and algaecide. Accordingly, chlorine dioxide is used in a variety of large scale industrial applications including municipal water treatment as a bactericide, still water treatment, water hygiene taste and odor control, and zebra mussel infestation control, to name a few. It is used to bleach paper and flour, and it is also particularly useful where microbes and/or organic odorants are sought to be controlled on and around foodstuffs.

Unfortunately, chlorine dioxide is not stable for long periods of time. Specifically, at normal operating pressures and temperatures, chlorine dioxide is a gas and is extremely explosive. For example, chlorine dioxide can be explosive at pressures above about 0.1 atmosphere. Therefore, chlorine dioxide gas is not manufactured and shipped under pressure like other industrial gases. Rather, due to its inherent instability, chlorine dioxide must be produced in situ at the point of use. Conventional methods of on-site manufacture prepare chlorine dioxide by oxidation of chlorites or reduction of chlorates, as needed. These conventional methods generally require expensive generation equipment and a high level of operator skill to avoid generating dangerously high concentrations. Due to these constraints, the use of chlorine dioxide has typically been limited to large commercial applications, such as pulp and paper bleaching, water treatment, and poultry processing, where the consumption of chlorine dioxide is sufficiently large that it can justify the capital and operating costs of expensive equipment and skilled operators for on-site manufacture.

### SUMMARY OF THE INVENTION

The present invention is directed to a method and apparatus for producing and dispensing a cleaning solution. The cleaning solution of some embodiments is produced by reacting or catalyzing one or more chemicals or reactants within a dispensing apparatus.

In some embodiments, the dispensing apparatus has one or more conduits, chambers, vessels, reservoirs, etc., wherein one or more portions of the dispenser contain a catalyst and/or reactant. As a precursor passes through the dispensing apparatus, it reacts in response to entering the portion containing the catalyst and/or reactant to form a cleaning solution or a precursor cleaning solution. This cleaning solution or precursor cleaning solution can be stored in a tank for dispensing. In some embodiments, one or more portions of the dispensing apparatus are coupled to a mobile platform. For example, the tank can be coupled to a mobile platform to allow the cleaning solution or precursor cleaning solution to be transported to a dispensing location.

In one particular application of the above embodiment, sodium chlorite is used as a precursor and is fed through an ion exchange bed to form chlorous acid or a cleaning solution precursor. The chlorous acid is stored in a tank for later use. When a cleaning solution is desired to be dispensed, the chlorous acid passes through a catalyst, which then produces chlorine dioxide. In some embodiments, the storage tank and catalyst are coupled to a mobile platform.

In another application of the above embodiment, chlorous acid is used as a precursor for a cleaning solution containing chlorine dioxide. Chlorous acid passes through the conduit toward a storage tank. Prior to reaching the storage tank, the chlorous acid is fed though a catalyst, which then produces chlorine dioxide. Immediately thereafter, the chlorine dioxide or chlorine dioxide solution can be introduced into water in a desired concentration (about 0-1500 ppm in some situations) and the chlorine dioxide cleaning solution is stored in the tank for quick dispensing. In some embodiments, one or more of the conduit, storage tank, and catalyst are coupled to a mobile platform.

In some embodiments, the dispensing apparatus has a first portion containing a first reactant, mixture of reactants, or other precursor used to produce the cleaning solution and a second portion containing a second reactant, mixture of reactants, other precursor, or catalyst used to produce the cleaning solution. The first portion of the dispenser is in fluid communication with the second portion. During the dispensing operation, the contents of the first portion contact the contents of the second portion, which causes a chemical reaction to produce the cleaning solution. Substantially immediately thereafter, the cleaning solution is used. In some embodiments, either the first portion or the second portion or both can be coupled to a mobile platform.

In one particular application of the above embodiment, the dispenser can generate chlorine dioxide on demand at end use points, which eliminates the need to generate and store high concentrations of chlorine dioxide. The first portion of the dispenser contains chlorous acid as a precursor to the generation of chlorine dioxide and the second portion of the dispenser contains a catalyst that catalyzes the reaction of chlorous acid to form chlorine dioxide. The chlorous acid is kept separate from the catalyst until chlorine dioxide is called for. Upon demand for chlorine dioxide, the chlorous acid is fed through the catalyst to produce chlorine dioxide. The chlorous acid flows through the catalyst during the dispensing operation.

The dispensers of the present invention can be used for continuous or batch production/dispensing. However, some embodiments have particular utility for batch dispensing. For example, some dispensers are mobile and can be effectively used for batch dispensing. As such, the dispenser can be transported to an end use location, which eliminates the need for installation of expensive equipment at the end use location. The dispenser can be coupled to a base that is mobile. For example, in one embodiment, the base has a plurality of wheels that allow the dispenser to be moved to a desired end use location. The dispenser can include a storage area and a reaction area coupled to the base. If the mobile dispenser is used for chlorine dioxide generation, the storage area can be used to store either a batch of chlorous acid or chlorine dioxide cleaning solution as described in the above embodiments.

In one method of producing and dispensing chlorine dioxide, sodium chlorite is stored in a controlled environment away from the dispensing point of use. The sodium chlorite is fed in a dilute form into an ion exchange resin bed where hydrogen (H⁺) is exchanged for sodium (Na⁺) to convert the sodium chlorite to chlorous acid or a relatively stable mixture containing chlorous acid. The chlorous acid is then transported closer to the point of use, where it is contained within a first portion of a dispenser. During a dispensing operation, the mixture containing chlorous acid contacts a catalyst, which causes chlorine dioxide to be produced. The chlorine dioxide is then dispensed in an aqueous solution for use as a cleaning solution.

These and other aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is a schematic representation of a cleaning solution generator and dispenser embodying aspects of the present invention, wherein the generator/dispenser is coupled to a clean-in-place system.

FIG. 2 is a schematic representation of another cleaning solution generator and dispenser embodying aspects of the present invention, wherein the generator/dispenser is coupled to a clean-in-place system.

FIG. 3 is a schematic of a mobile dispenser embodying aspects of the present invention, where a storage tank is filled with a precursor to a cleaning solution. The dispenser is also illustrated as being in communication with a clean-in-place system.

FIG. 4 is a schematic of the mobile dispenser of FIG. 3, where the contents of the storage tank are substantially completely dispensed to the clean-in-place system.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

### DESCRIPTION OF THE ILLUSTRATED EMBODIMENTS

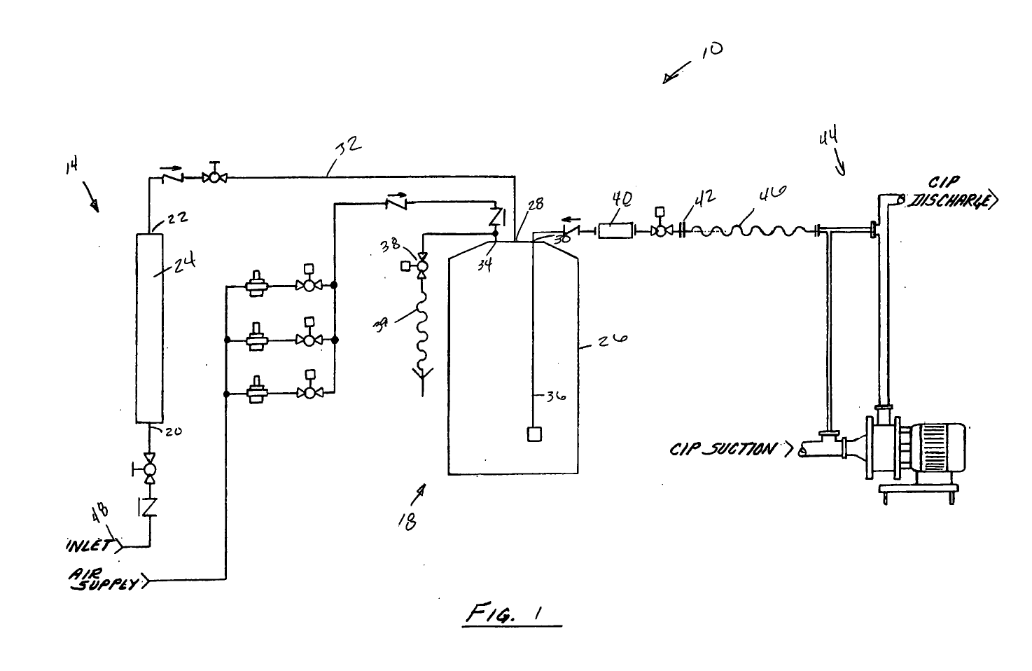

FIG. 1 illustrates one embodiment of a cleaning solution generating and dispensing apparatus 10 embodying aspects of the present invention. Specifically, this apparatus 10 can produce and dispense a chlorine dioxide cleaning solution. However, this apparatus 10 can also be used to or adapted to produce and dispense other cleaning solutions. Thus, although the description provided below will primarily discuss the illustrated embodiment relative to the generation and dispense of a chlorine dioxide cleaning solution, the apparatus can be used to produce and dispense other cleaning solutions.

The apparatus 10 includes a chemical reaction area 14 coupled to a storage area 18. The chemical reaction area 14 has an inlet 20 and an outlet 22. A precursor chemical enters the inlet 20, reacts within the reaction area 14, and then passes through the outlet 22. Depending upon the chemicals involved and/or the type of reaction desired, the chemical reaction area 14 can be a fluid passage or conduit, such as a pipe or other line, or it can be a tank, vessel, chamber, or other container. The reaction area 14 can also contain one or more reactants, catalysts, precursors, or the like. In the embodiment illustrated in FIG. 1, in which the reaction area 14 is used to generate chlorine dioxide, a catalyst is contained within a container 24 of the reaction area 14.

As the precursor chemical is fed through the container 24 of the reaction area 14, a chemical reaction occurs to form a precursor cleaning solution or cleaning solution. In the present example, chlorous acid is fed through the catalyst to form chlorine dioxide, which can be used as a cleaning solution. The specifics of this reaction and other similar reactions are known in the art and therefore will not be discussed herein. United States Published Application No. 2003/0064018, which is hereby incorporated by reference, discusses the chemistry regarding conversion of chlorous acid via a catalyst to chlorine dioxide.

The product of the reaction of this embodiment is then sent to the storage area 18. The storage area 18 can be a fluid passage, conduit, container, or the like. In the illustrated embodiment, the storage area is a tank 26. The tank 26 has a product inlet 28 and a product outlet 30. The product inlet 28 communicates with the reaction area via a conduit 32. The product outlet 30 has a dip tube 36 with an opening positioned near the bottom of the tank 26. The product can exit the tank 26 through the dip tube 36 with the assistance of air pressure.

As illustrated, the tank 26 has a pressurized air inlet 34. The inlet 34 is coupled to a source of pressurized air, where the amount and pressure of the air entering the tank 26 can be regulated many different ways. For example, one or more valves and pressure regulators can be used to control the amount and pressure of the air delivered to the tank. The pressurized air assists with dispensing the product from the tank 26. Specifically, it increases the pressure within the tank 26, which forces the product out of the tank 26 through the dip tube 36. The pressure can control the concentration of chlorine dioxide wherein a higher pressure can result in a higher concentration of chlorine dioxide.

The pressurized air inlet 34 can also be used as an outlet for the tank 26 as well. Once some or all of the product has been dispensed from the tank 26, a substantial quantity of air can remain in the tank 26. As the tank 26 is being refilled with product, one or more valves 38 can be opened to allow the air pressure to escape. As illustrated, a filter 39 back flow preventer 29 can be located adjacent the valve to filter the fluid exiting the tank 26 via outlet 34, which could contain limited amounts of chlorine dioxide. Any chlorine dioxide that is expelled in the aforementioned way can be gathered as a source of purified chlorine dioxide for further use.

Product can be drawn from the tank 26 via a flow controller 40 that is coupled to the outlet 30 of the tank 26. The flow controller 40 can control the amount of product dispensed from the tank 26 in response to an operator's intent. One type of flow controller is a venture, which uses pressure to expel the cleaning solution. However, other flow controllers can be used.

The apparatus 10 also has a product dispensing outlet 42 through which product is dispensed. In some embodiments, this outlet 42 is provided with a quick connect fitting to allow quick connection with a system needing the product. For example, as illustrated in FIG. 1, the apparatus 10 can be coupled to a clean-in-place system 44 via a conduit 46.

In one particular operation of the apparatus 10 illustrated in FIG. 1, a chlorine dioxide cleaning solution can be produced and dispensed. Chlorous acid, produced upstream of the apparatus 10, enters the apparatus 10 via an inlet 48 and is delivered to the reaction area 14. In the reaction area 14, the chlorous acid is fed through the catalyst in container 24. Consequently, chlorine dioxide in generated. The chlorine dioxide is then stored in tank 26. In some embodiments, the amount produced and stored in the tank is sufficient for one cleaning operation (i.e., a batch). Once chlorine dioxide is to be dispensed, a desired quantity of air and air pressure drives a proportionate quantity of chlorine dioxide or chlorine dioxide solution from the tank and into a water stream, such as the water stream of a clean-in-place system, process water in flumes or poultry chillers, make-up water in water treatment or tunnel washers, or into any water or other media where chlorine dioxide is desired.

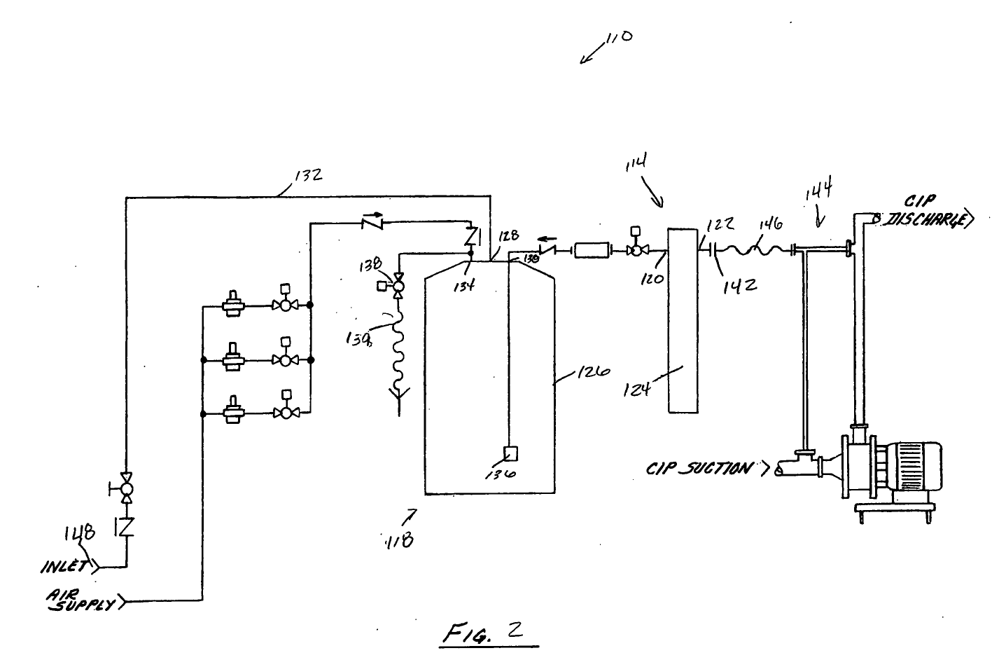

FIG. 2 illustrates a second embodiment of the present invention. Several features and/or structures of this embodiment are the same or similar to the previous embodiment. As such, these similar features and structures will be given the same number as in the previous embodiment, but in the “100” series. For example, “9” in the previous embodiment would correspond to “109” in the present embodiment. Furthermore, generally only those features not previously discussed will be discussed in detail.

Like the cleaning solution generating and dispensing apparatus 10 of FIG. 1, the cleaning solution generating and dispensing apparatus 110 of FIG. 2 can produce and dispense a chlorine dioxide cleaning solution. However, this apparatus 110 can also be used to produce and dispense other cleaning solutions. Although the apparatus can be used to produce and dispense other cleaning solutions, the description provided below will primarily discuss the illustrated embodiment relative to the generation and dispense of a chlorine dioxide cleaning solution.

The apparatus 110 includes a chemical reaction area 114 coupled to a storage area 118. Unlike the previous embodiment of FIG. 1, the chemical reaction area 114 is positioned downstream of the storage area 118. Accordingly, chemical reactants or precursor chemicals, such as chlorous acid, flow directly to the storage area 118 where they are stored until an end product is needed to be dispensed. Upon demand, the precursor chemicals are fed to the reaction area 114 where reaction occurs just prior to use. In contrast, in the previous embodiment of FIG. 1, the precursor was reacted upstream of the storage area, and accordingly, the end product was stored in the storage area 18.

The storage area 118 of FIG. 2, like the storage area 18 of FIG. 1, can be a passage, conduit, container, or the like. In the illustrated embodiment, the storage area 118 is a tank 126. The tank 126 has a precursor inlet 128 and a precursor outlet 130. The precursor inlet 128 communicates with a source of precursor. The precursor outlet 130 has a dip tube 136 with an opening positioned near the bottom of the tank 126. The precursor exits the tank 126, upon demand, through the dip tube 136 with the assistance of air pressure, as described above. Accordingly, the tank 126 has a pressurized air inlet 134. Similar to the previous embodiment, the pressurized air inlet 134 of the tank 126 can also be used as an outlet to vent air and other gases from the tank 126 and allow more room for precursor.

Precursor can be drawn from the tank 126 via a flow controller 140 coupled to the outlet 122 of the tank 126. Precursor is delivered to the reaction area 114 prior to dispensing. The flow controller 140 can control the amount of precursor dispensed from the tank 126 in response to an operator's intent. The precursor chemical enters the inlet 120 of the reaction area 114 and reacts within the reaction area 114. The product of the reaction then passes through the outlet 122 of the reaction area 114 to be dispensed. Depending upon the chemicals involved and/or the type of reaction desired, the chemical reaction area 114 can be a passage or conduit, such as a pipe or other line, or it can be a tank, vessel, chamber, or other container. The reaction area 114 contains one or more reactants, catalysts, precursors, or the like. Assuming the illustrated embodiment is used to generate chlorine dioxide, a catalyst for driving chlorous acid to chlorine dioxide is contained within container 124.

Like the previous embodiment of FIG. 1, the apparatus 110 of FIG. 2 also has a product dispensing outlet 142 in fluid connection with the suction or driving source 140 through which product is dispensed. The suction source 140 may be located as shown in FIG. 2 after the container 124 or prior to the container 124. In some embodiments, this outlet 142 is provided with a quick connect fitting to allow quick connection with a system needing the product, such as a clean-in-place system 144.

One particular operation of the apparatus 110 illustrated in FIG. 2 will now be described with reference to the generation and dispense of a chlorine dioxide cleaning solution. Chlorous acid, produced upstream of the apparatus 110, enters the apparatus 110 via an inlet 148 and is delivered to the storage area 118. The storage area 118 is sized to receive a desired amount of chlorous acid. Upon demand for production and dispense of a chlorine dioxide cleaning solution, chlorous acid is fed from the storage tank 118 to the reaction area 114 via introduction of air pressure to the storage tank 118. The air pressure can be controlled to control the concentration and delivery rate of the dispensed product. In the reaction area 114, the chlorous acid is fed through the catalyst in container 124. Consequently, chlorine dioxide in generated. The chlorine dioxide is then immediately fed into media where chlorine dioxide is desired, such as the water stream of a clean-in-place system, process water in flumes or poultry chillers, make-up water in water treatment or tunnel washers, or into any other water and the like.

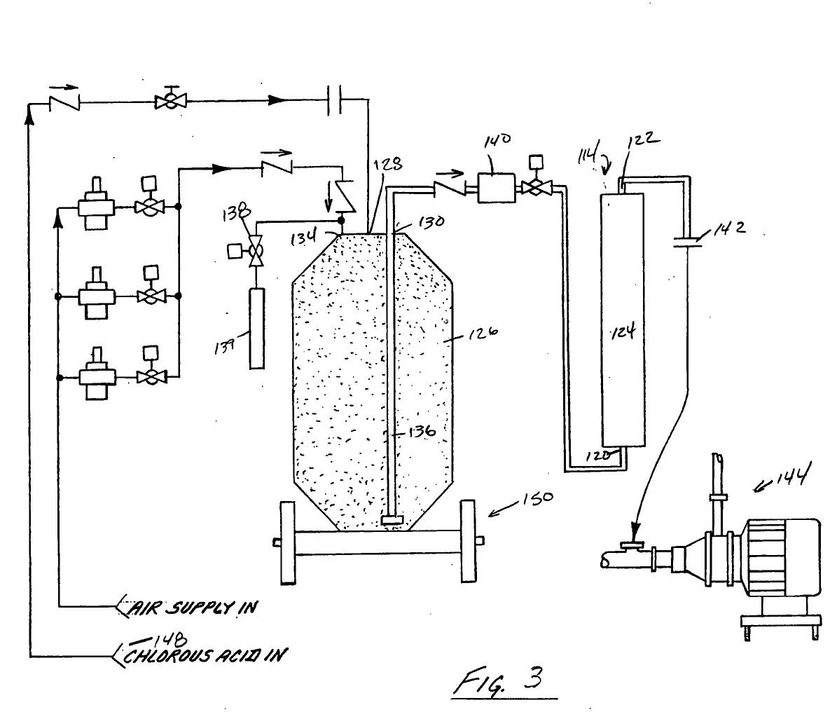

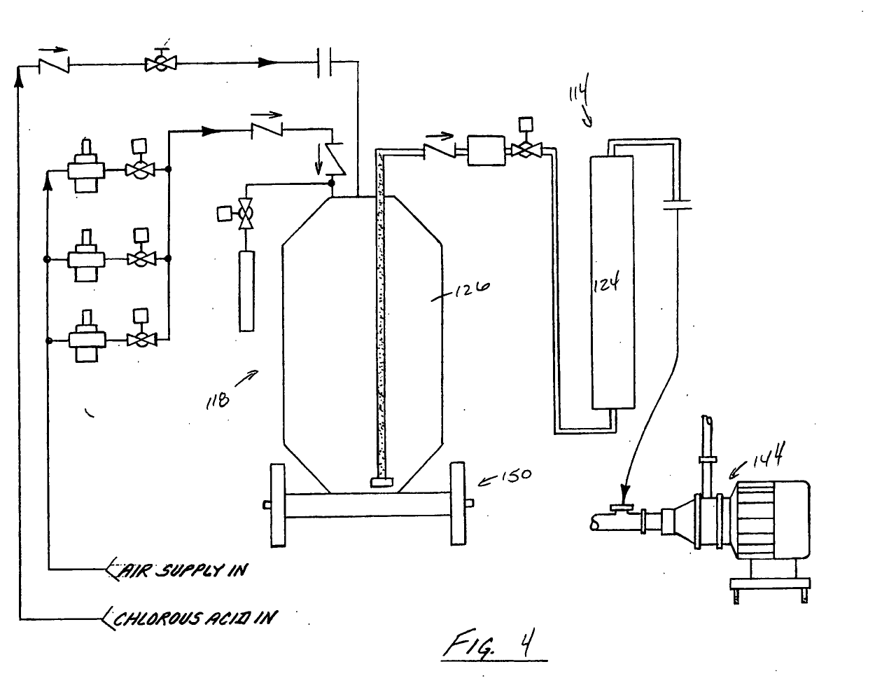

FIGS. 3 and 4 illustrate a cleaning solution generation and dispensing apparatus 110 that is substantially identical to the apparatus 110 illustrated in FIG. 2. The main difference between FIG. 2 and FIGS. 3 and 4 is that the apparatus 110 of FIGS. 3 and 4 is illustrated as being mobile, while the apparatus 110 of FIG. 2 is not illustrated as being mobile. Specifically, the apparatus 110 of FIGS. 3 and 4 is coupled to a mobile platform 150, allowing it to be moved to a variety of use locations. Although it is not specifically shown, the storage tank and the catalyst container can be coupled to the platform. Accordingly, the need for expensive production and dispensing equipment at each end us location is eliminated. Although the systems of FIGS. 1 and 2 are not illustrated as being mobile, these systems can be coupled to a mobile platform 150 to become mobile.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features of the invention are set forth in the following claims.

We claim:

1. A mobile apparatus for producing and dispensing a cleaning solution at a point of use, the apparatus comprising:
a mobile platform,
a first fluid passage coupled to the mobile platform and adapted to contain a precursor cleaning solution, the first fluid passage having an inlet for selectively receiving the precursor cleaning solution and an outlet for delivering the precursor cleaning solution; and
a second fluid passage coupled to the mobile platform and in selective fluid communication with the outlet of the first fluid passage, the second fluid passage adapted to promote reaction of the precursor to produce a cleaning solution, the second fluid passage having an outlet for dispensing the cleaning solution at a point of use.

2. The apparatus of claim 1, wherein the first fluid passage is a storage tank.

3. The apparatus of claim 2, wherein the tank has an inlet for pressurized air, the pressurized air adapted to drive the precursor from the tank upon demand.

4. The apparatus of claim 3, further comprising a controller that controls the amount and pressure of air provided to the tank, which controls the concentration of the cleaning solution.

5. The apparatus of claim 2, wherein the second fluid passage is a passage containing a catalyst for catalyzing the reaction of the precursor solution.

6. The apparatus of claim 5, wherein the precursor is chlorous acid and the cleaning solution contains chlorine dioxide.

7. A method of producing and dispensing a cleaning solution, the method comprising:
providing an apparatus for both producing a cleaning solution from a precursor and for dispensing the cleaning solution;
filling a tank of the apparatus with precursor;
initiating a dispensing operation;
forcing precursor from the tank in response to the dispensing operation being initiated;
feeding the precursor forced from the tank through a second portion of the apparatus;
causing a reaction of the precursor by feeding it through the second portion of the apparatus to form a cleaning solution;
producing a cleaning solution from the product of the reaction; and
dispensing the cleaning solution from the apparatus.

8. The method of claim 7, wherein forcing precursor from the tank comprises increasing the air pressure within the tank to force the precursor from the tank.

9. The method of claim 8, further comprising adjusting at least one of the amount and pressure of air delivered to the tank to control the volume of the cleaning solution.

10. The method of claim 7, further comprising releasing gases formed within the tank during the filling operation to make additional room for precursor.

11. The method of claim 7, wherein the precursor is chlorous acid, the second portion contains a catalyst, and the product of the reaction is chlorine dioxide

12. The method of claim 7, wherein dispensing a cleaning solution from the product of the reaction further comprises introducing the product into water to form an aqueous cleaning solution.

13. The method of claim 7, further comprising transporting the tank filled with precursor to a dispensing location prior to initiating a dispensing operation.

14. An apparatus for producing and dispensing a cleaning solution, the apparatus comprising:
a precursor inlet for receiving chlorous acid from a source of chlorous acid;
a tank having a first inlet in fluid communication with the precursor inlet for receiving chlorous acid and a first outlet for draining chlorous acid stored within the tank, the tank also having an aperture selectively allowing pressurized gases to enter and escape the tank;
a conduit in fluid communication with the outlet of the tank, the conduit containing a catalyst adapted to convert chlorous acid to chlorine dioxide upon contacting chlorous acid; and
an outlet in fluid communication with the conduit for dispensing the chlorine dioxide.

15. The apparatus of claim 14, further comprising a mobile platform, wherein the precursor inlet, the tank, the conduit, and the outlet are coupled to the mobile platform.

16. The apparatus of claim 14, wherein pressurized gases are forced into the tank through the aperture to drive the chlorous acid from the tank and into the conduit, the pressure of the pressurized gases forced into the tank controls the volume of chlorine dioxide dispensed.

17. The apparatus of claim 14, wherein gases formed within the tank are vented through the aperture to allow additional room for chlorous acid within the tank.

18. A cleaning solution dispenser comprising:
a inlet for receiving a precursor solution from a precursor solution source;
a reactor in fluid communication with the inlet, the precursor solution reacting within the reactor to form a cleaning solution;
a tank in fluid communication with the reactor for receiving cleaning solution and temporarily storing the cleaning solution, the tank having an aperture selectively allowing pressurized gases to enter and escape the tank, pressurized gases are forced into the tank through the aperture to dispense the cleaning solution and control the volume of the cleaning solution; and
an outlet in fluid communication with the tank for dispensing the cleaning solution from the dispenser.

19. The dispenser of claim 18, wherein the precursor is chlorous acid and the cleaning solution contains chlorine dioxide.

20. The dispenser of claim 19, wherein the reactor contains a catalyst adapted to convert chlorous acid to chlorine dioxide upon contacting chlorous acid.

21. The dispenser of claim 18, further comprising a mobile platform, wherein the inlet, reactor, tank, and outlet are coupled to the mobile platform.

22. A method of producing and dispensing a cleaning solution, the method comprising:
providing an apparatus for producing a cleaning solution from a precursor and for dispensing the cleaning solution;
causing a precursor material to flow through a conduit of the apparatus;
initiating a reaction of the precursor to form a cleaning solution as it flows through the conduit;
storing a product of the reaction within a tank coupled to the apparatus;
initiating a dispensing operation;
forcing the product from the tank by increasing the air pressure within the tank to force the product to a dispensing area of the apparatus; and dispensing the product forced from the tank.

23. The method of claim 22, further comprising adjusting at least one of the amount and pressure of air delivered to the tank to control the volume of the cleaning solution.

24. The method of claim 22, wherein the precursor is chlorous acid, the conduit contains a catalyst, and the product of the reaction is chlorine dioxide.

25. The method of claim 22, further comprising introducing the product of the reaction into water to form an aqueous cleaning solution.

26. The method of claim 22, further comprising transporting the tank with the product of the reaction to a dispensing location prior to initiating a dispensing operation.

27. An apparatus for producing and dispensing a cleaning solution, the apparatus comprising:
a precursor inlet for receiving chlorous acid from a source of chlorous acid;
a conduit in fluid communication with the precursor inlet, the conduit containing a catalyst adapted to convert chlorous acid to chlorine dioxide upon contacting chlorous acid;
a tank having a first inlet in fluid communication with the conduit for receiving chlorine dioxide and a first outlet for draining chlorine dioxide stored within the tank, the tank also having an aperture selectively allowing pressurized gases to enter and escape the tank; and
an outlet in fluid communication with the conduit for dispensing the chlorine dioxide wherein pressurized gases are forced into the tank through the aperture to drive the chlorine dioxide from the tank, the pressure of the pressurized gases forced into the tank controls the concentration of chlorine dioxide.

28. The apparatus of claim 27, further comprising a mobile platform, wherein the precursor inlet, the conduit, the tank, and the outlet are coupled to the mobile platform.

29. The apparatus of claim 27 wherein the aperture is in communication with a filter which emits purified chlorine dioxide into collection tanks.

30. A mobile apparatus for producing and dispensing a chlorine dioxide cleaning solution at a point of use, the apparatus comprising:
a mobile platform,
a first fluid passage coupled to the mobile platform and adapted to contain chlorous acid, the first fluid passage having an inlet for selectively receiving the chlorous acid and an outlet for delivering the chlorous acid; and
a second fluid passage coupled to the mobile platform and in selective fluid communication with the outlet of the first fluid passage, the second fluid passage adapted to promote reaction of the chlorous acid to produce chlorine dioxide for use as a chlorine dioxide cleaning solution, the second fluid passage having an outlet for dispensing the chlorine dioxide cleaning solution at the point of use.

31. The apparatus of claim 30, wherein the first fluid passage is a storage tank.

32. The apparatus of claim 31, wherein the storage tank further comprises an inlet for pressurized air, the pressurized air adapted to drive the chlorine dioxide cleaning solution from the tank upon demand.

33. The apparatus of claim 32, further comprising a controller that controls the amount and pressure of air provided to the tank, which controls the concentration of the chlorine dioxide cleaning solution.

34. The apparatus of claim 31, wherein the second fluid passage is a passage containing a catalyst for catalyzing the reaction of the chlorous acid.

35. The apparatus of claim 30, wherein the chlorine dioxide cleaning solution includes chlorine dioxide introduced to water.

36. A method of producing and dispensing a chlorine dioxide cleaning solution, the method comprising:
providing an apparatus for both producing a chlorine dioxide cleaning solution from chlorous acid and for dispensing the chlorine dioxide cleaning solution;
filling a first portion of the apparatus with chlorous acid;
initiating a dispensing operation;
forcing chlorous acid from the first portion in response to the dispensing operation being initiated;
feeding the chlorous acid forced from the first portion through a second portion of the apparatus;
causing a reaction of the chlorous acid by feeding it through the second portion of the apparatus;
producing a chlorine dioxide cleaning solution from the product of the reaction; and
dispensing the chlorine dioxide cleaning solution from the apparatus.

37. The method of claim 36, wherein forcing chlorous acid from the first portion comprises increasing the air pressure within the tank to force the chlorous acid from the first portion.

38. The method of claim 37, further comprising adjusting at least one of the amount and the pressure of air delivered to the first portion to control the concentration of the chlorine dioxide cleaning solution.

39. The method of claim 36, further comprising releasing gases formed within the first portion during the filling operation to make additional room for chlorous acid.

40. The method of claim 36, wherein the second portion contains a catalyst that reacts with chlorous acid to produce chlorine dioxide.

41. The method of claim 36, wherein producing a chlorine dioxide cleaning solution from the product of the reaction further comprises introducing the product of reaction into water to form an aqueous chlorine dioxide cleaning solution.

42. The method of claim 36, further comprising transporting the apparatus to a dispensing location prior to initiating a dispensing operation.

43. An apparatus for producing and dispensing a chlorine dioxide cleaning solution, the apparatus comprising:
a precursor inlet for receiving chlorous acid from a source of chlorous acid;
a tank for storing chlorous acid, the tank having a first inlet in fluid communication with the precursor inlet for receiving chlorous acid and a first outlet for draining chlorous acid stored within the tank, the tank also having an aperture selectively allowing pressurized gases to enter and escape the tank;
a conduit in fluid communication with the outlet of the tank, the conduit containing a catalyst adapted to convert chlorous acid to chlorine dioxide upon contacting the chlorous acid; and
an outlet in fluid communication with the conduit for dispensing the chlorine dioxide.

44. The apparatus of claim 43, further comprising a mobile platform, wherein the precursor inlet, the tank, the conduit, and the outlet are coupled to the mobile platform.

45. The apparatus of claim 43, wherein pressurized gases are forced into the tank through the aperture to drive the chlorous acid from the tank and into the conduit, the pressure of the pressurized gases forced into the tank controls the concentration of chlorine dioxide dispensed.

46. The apparatus of claim 43, wherein the tank includes a vent, gases formed within the tank are vented through the aperture to allow additional room for chlorous acid within the tank.

47. A chlorine dioxide cleaning solution dispenser comprising:
a inlet for receiving a chlorous acid solution from a chlorous acid solution source;
a reactor in fluid communication with the inlet, the chlorous acid solution reacting within the reactor to form chlorine dioxide for use in a chlorine dioxide cleaning solution;
a tank in fluid communication with the reactor for receiving chlorine dioxide and temporarily storing the chlorine dioxide cleaning solution, the tank having an aperture selectively allowing pressurized gases to enter and escape the tank, pressurized gases are forced into the tank through the aperture to dispense the chlorine dioxide cleaning solution and control the concentration of the chlorine dioxide cleaning solution; and
an outlet in fluid communication with the tank for dispensing the chlorine dioxide cleaning solution from the dispenser.

48. The dispenser of claim 47, wherein the chlorine dioxide is introduced into water to form the chlorine dioxide cleaning solution.

49. The dispenser of claim 48, wherein the reactor contains a catalyst adapted to convert chlorous acid to chlorine dioxide upon contacting the chlorous acid.

50. The dispenser of claim 47, further comprising a mobile platform, wherein the inlet, reactor, tank, and outlet are coupled to the mobile platform.

51. A method of producing and dispensing a chlorine dioxide cleaning solution, the method comprising:
providing an apparatus for producing a chlorine dioxide cleaning solution from chlorous acid and for dispensing the chlorine dioxide cleaning solution;
causing chlorous acid to flow through a conduit of the apparatus;
initiating a reaction of the chlorous acid to form chlorine dioxide as it flows through the conduit;
storing the chlorine dioxide within a tank coupled to the apparatus;
initiating a dispensing operation;
forcing the chlorine dioxide from the tank by increasing the pressure within the tank to force the chlorine dioxide to a dispensing area of the apparatus; and
dispensing the chlorine dioxide forced from the tank.

52. The method of claim 51, further comprising adjusting at least one of the amount and the pressure of air delivered to the tank to control the concentration of the cleaning solution.

53. The method of claim 51, wherein the conduit contains a catalyst for initiating the reaction.

54. The method of claim 51, further comprising introducing the chlorine dioxide into water to form an aqueous chlorine dioxide cleaning solution.

55. The method of claim 51, further comprising transporting the tank filled with chlorine dioxide to a dispensing location prior to initiating a dispensing operation.
